(19) United States
(12) Patent Application Publication
(10) Pub. No.: US 2021/0023713 A1
(43) Pub. Date: Jan. 28, 2021

(54) Method of Automated Calibration for In-Hand Object Location System

(71) Applicant: ABB Schweiz AG, Baden (CH)

(72) Inventors: Biao Zhang, West Hartford, CT (US); Yixin Liu, South Windsor, CT (US); Thomas A. Fuhlbrigge, Ellington, CT (US); Saumya Sharma, Albany, NY (US)

(73) Assignee: ABB Schweiz AG, Baden (CH)

(21) Appl. No.: 16/521,061

(22) Filed: Jul. 24, 2019

(51) Int. Cl. B25J 9/16; B25J 13/08

(52) U.S. Cl. CPC B25J 9/1692; B25J 13/084; B25J 9/1697

(57) ABSTRACT

A method of automated in-hand calibration including providing at least one robotic hand including a plurality of grippers connected to a body and providing at least one camera disposed on a periphery surface of the plurality of grippers. The method also includes providing at least one tactile sensor disposed in the at least one illumination surface and actuating the plurality of grippers to grasp an object. The method further includes locating a position of the object with respect to the at least one robotic hand and calibrating a distance parameter via the at least one camera. The method also includes calibrating the at least one tactile sensor with the at least one camera and generating instructions to grip and manipulate an orientation of the object via an image feed from the at least one camera for a visualization of the object.

### BACKGROUND OF THE INVENTION

Industrial robots are well known in the art. Such robots are intended to replace human workers in a variety of assembly tasks. It has been recognized that in order for such robots to effectively replace human workers in increasingly more delicate and detailed tasks, it will be necessary to provide sensory apparatus for the robots which is functionally equivalent to the various senses with which human workers are naturally endowed, for example, sight, touch, etc.

In robotic picking applications for small part assembly, warehouse/logistics automation, food and beverage, etc., a robot gripper needs to pick an object, then insert/place it accurately into another part. There are some traditional solutions: (1.) Customized fingers on the gripper can self-align the part to a fixed location relative to the gripper. But for different shape of the part, a different type of finger has to be made and changed. (2.) After picking up the part, the robot brings the part in front of a camera and a machine vision system detects the location of the part relative the gripper. But this extra step increases the cycle time for the robot system. (3.) The part is placed on a customized fixture and the robot is programmed to pick up the part at the same location each time. But various fixtures have to be made for different parts which may not be cost effective to produce.

Of particular importance for delicate and detailed assembly tasks is the sense of touch. Touch can be important for close-up assembly work where vision may be obscured by arms or other objects, and touch can be important for providing the sensory feedback necessary for grasping delicate objects firmly without causing damage to them. Touch can also provide a useful means for discriminating between objects having different sizes, shapes or weights. Accordingly, various tactile sensors have been developed for use with industrial robots.

However, there are problems such as easy wear and tear damage with this sensor for robotic picking and assembly applications that need to be overcome. In this problem, the robot hand is constantly picking parts and assembling parts which means that the finger/gripper surface is prone to abrasion/wear. This implies that any tactile sensing which employs fragile thin film coatings at grip points can easily wear off. Also, any elaborate light/LED source configuration limits the size of the in-hand object location system. An additional problem is the size of the light source and sensor are too big to mount on small robotic fingers to pick up small objects. Thus, mounting an elaborate light source for in-hand perception is not feasible. The current state of the art lacks information on object handling/gripping as a part of the robot hand.

Further, there are problems such as easy wear and tear damage with this sensor for robotic picking and assembly applications that need to be overcome. In this problem, the robot hand is constantly picking parts and assembling parts which means that the finger/gripper surface is prone to abrasion/wear. This implies that any tactile sensing which employs fragile thin film coatings at grip points can easily wear off. Also, such an elaborate light/LED source limits the size of the in-hand object location system. Therefore, an additional problem is the size of the light source and sensor may be too big to mount on small robotic fingers to pick up small objects. Thus, mounting an elaborate light source for in-hand perception is not feasible. Another problem is that adding an in-hand light source and detector means that there will be a need for an extra calibration step.

### BRIEF SUMMARY OF THE INVENTION

The invention provides a method of automated in-hand calibration including providing at least one robotic hand including a plurality of grippers connected to a body and providing at least one camera disposed on a periphery surface of the plurality of grippers. The method also includes providing at least one tactile sensor disposed in the at least one illumination surface and actuating the plurality of grippers to grasp an object. The method further includes locating a position of the object with respect to the at least one robotic hand and calibrating a distance parameter via the at least one camera. The method also includes calibrating the at least one tactile sensor with the at least one camera and generating instructions to grip and manipulate an orientation of the object via an image feed from the at least one camera for a visualization of the object. The at least one robotic hand, the plurality of grippers, the at least one camera and the at least one tactile sensor are electrically connected to a controller. The method further includes gripping and manipulating the object based on the generated instructions and a first determining whether or not a feed from the visualization of the object correlates with the generated instructions. The method also includes a first correcting the gripping and manipulating of the object based on the first determining and a second determining whether or not a feed from the at least one tactile sensor correlates with the generated instructions. The method further includes a second correcting the gripping and manipulating of the object based on the second determining and placing the object in an assembly of parts.

The invention provides a robotic hand including a plurality of grippers and a body and at least one camera disposed on a periphery surface of the plurality of grippers. The invention also includes at least one illumination surface disposed on a periphery surface of the plurality of grippers and at least one tactile sensor disposed in the at least one illumination surface. The at least one robotic hand, the plurality of grippers, the at least one camera, the at least one illumination surface and the at least one tactile sensor are electrically connected to a controller.

The invention provides a non-transitory computer-readable medium storing instructions that, when executed by a processor of a computer, cause the processor to perform operations which include actuating the plurality of grippers to grasp an object and locating a position of the object with respect to the at least one robotic hand. The invention also includes calibrating a distance parameter via the at least one camera and calibrating the at least one tactile sensor with the at least one camera. The invention further includes generating instructions to grip and manipulate an orientation of the object via an image feed from the at least one camera for a visualization of the object.

### BRIEF DESCRIPTION OF THE SEVERAL VIEWS OF THE DRAWING(S)

FIG. 1 is a perspective view of a pick and place assembly device in accordance with the disclosure.

FIG. 2A is a perspective view of a tactile sensor in accordance with the disclosure.

FIG. 2B is a perspective view of another tactile sensor in accordance with the disclosure.

FIG. 3A is a perspective view of a 3D sensor film in accordance with the disclosure.

FIG. 3B is a perspective view of a 3D reconstruction of an object disposed on the 3D sensor film of FIG. 3A.

FIG. 4A is a diagrammatic view of the structure of a 3D in-hand sensor in accordance with the disclosure.

FIG. 4B is a perspective view of the 3D in-hand sensor of FIG. 4A.

FIG. 5A is a plan view of an in-hand object location system in accordance with the disclosure.

FIG. 5B is a diagrammatic view of a tactile sensor in accordance with the disclosure.

FIG. 6 is schematic view of a distributed control system architecture in accordance with the disclosure.

FIG. 7 is a flowchart of an in-hand calibration method for the object location system in accordance with the disclosure.

FIG. 8 is a flowchart of a set up and run time method for the in-hand object location system in accordance with the disclosure.

FIG. 9 is a flowchart for a method of automated in-hand calibration according to an embodiment.

FIG. 10 is a block diagram of a storage medium storing machine-readable instructions in according to an embodiment.

FIG. 11 is a flow diagram for a system process contained in a memory as instructions for execution by a processing device coupled with the memory according to an embodiment.

### DETAILED DESCRIPTION OF THE INVENTION

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The lack of information about the workpiece/object and its dimensions/surface characteristics is a major hurdle in planning the next optimization steps for object handling. Such an in-hand object recognition system can not only provide information about the object but also serve as a method for automatic calibration for the in-hand object location system, wherein a known motion is performed with the object as a reference point.

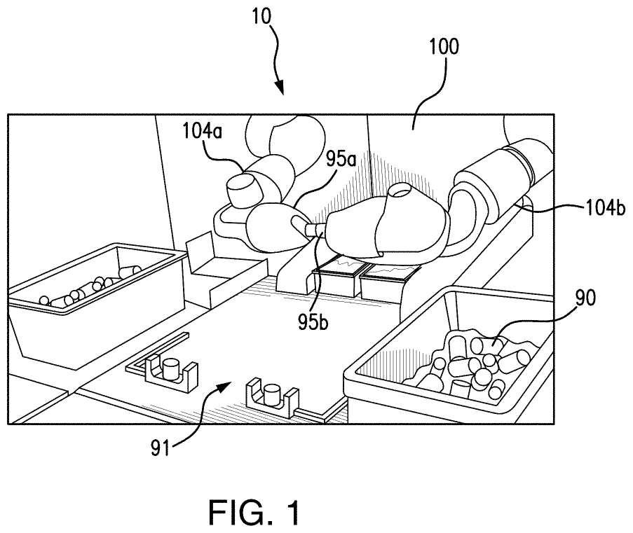

Referring now to FIG. 1, this is a robot button switch picking and assembly system 10. In many applications, the robot system 10 needs to know the accurate location of a part relative to a robot gripper after the robot picks up the part. In certain embodiments, system 10 includes an in-hand object location device, as discussed below.

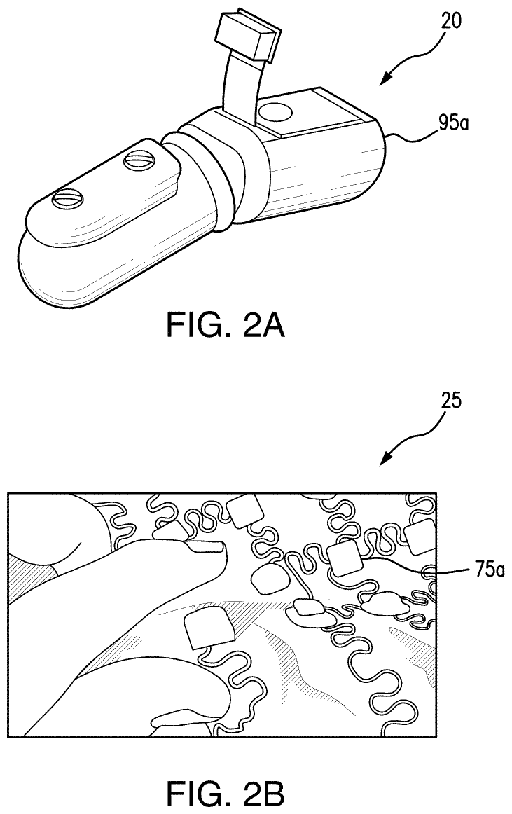

Referring now to FIGS. 2A and 2B, there are a tactile sensors 20, 25 used for in-hand object location. A tactile sensor is a device that can measure contact forces between the part and the gripper. These sensors may be mounted or incorporated on or within a robot gripper finger and may be used to detect the in-hand object location. However, the space resolution of the tactile sensors 20, 25 is low, so it cannot provide accurate in-hand part location for the picking, placing and assembly application.

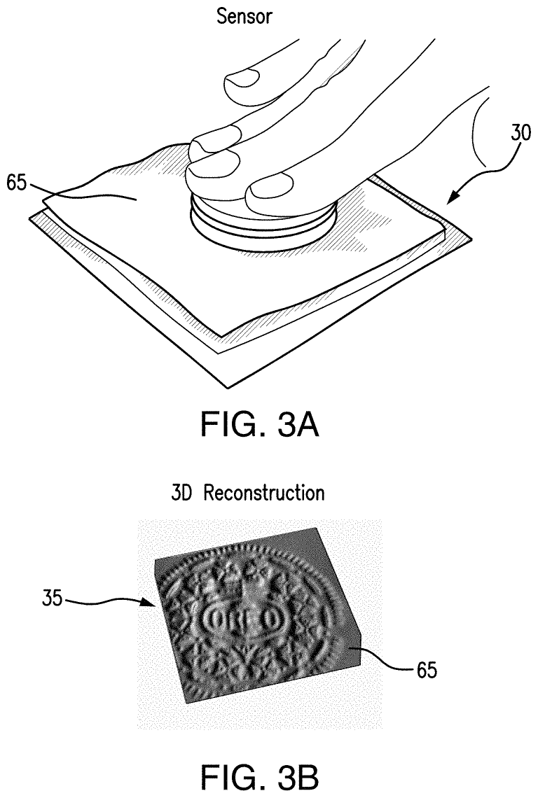

Referring now to FIGS. 3A and 3B, there is an in-hand sensor film 30, for example a GELSIGHT sensor gel film, provides high resolution (up to 2 micron) 3D reconstruction at 35 of the geometry of an in-hand object as taught in U.S. Pat. Pub. 2014/0104395, entitled Methods of and System for Three-Dimensional Digital Impression and Visualization of Objects through an Elastomer, filed Oct. 17, 2013 the subject matter of which is incorporated by reference in its entirety herein.

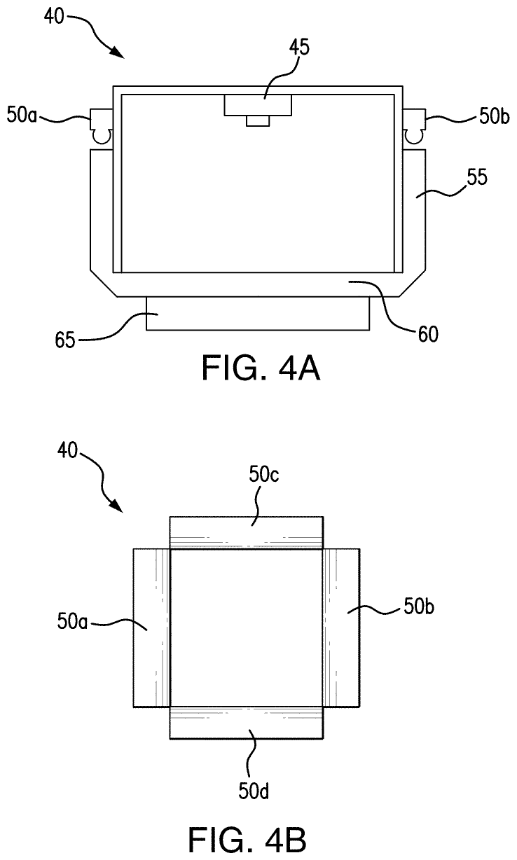

Referring now to FIGS. 4A and 4B, there is an in-hand sensor 40. Sensor 40 can be used to provide highly accurate location of in-hand object and may include a camera 45, LEDs 50a-d, light guide plate 55, a support plate 60 and elastomer gel 65 similar to sensor film 30 of FIG. 3A.

Further, the in-hand sensor 40 may include a block of transparent rubber or gel, one face of which is coated with metallic paint. When the paint-coated face is pressed against an object, it conforms to the object's shape. The metallic paint makes the object's surface reflective, so its geometry becomes much easier for computer vision algorithms to infer. Mounted on the sensor opposite the paint-coated face of the rubber block are colored lights/LEDs 50a-d and a single camera 45. This system needs to have colored lights at different angles, and then it has the reflective material, and by looking at the colors, a computer can figure out a 3-D shape of what is being sensed or touched.

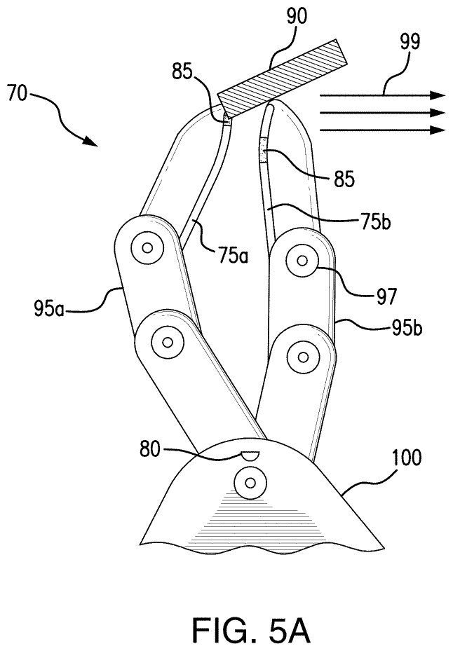

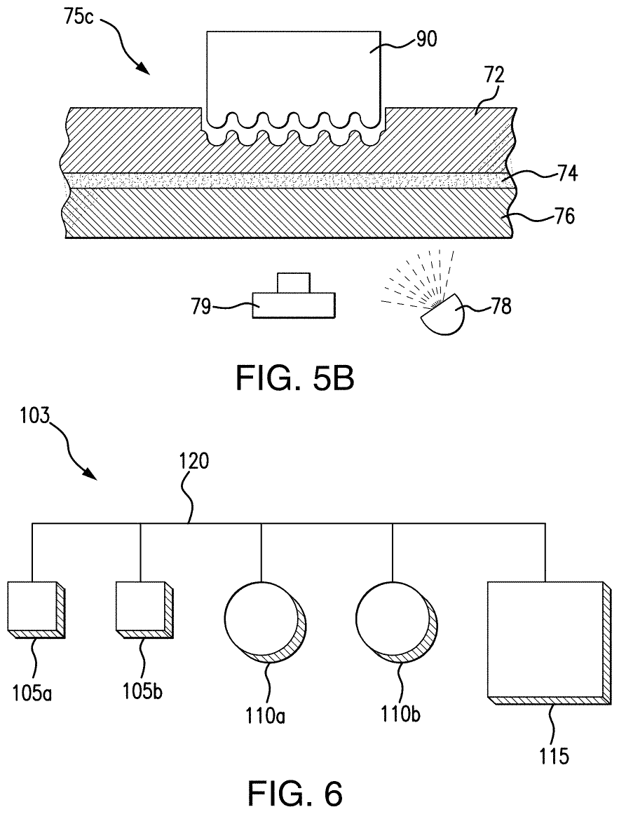

Referring now to FIGS. 5A and 5B, there is an in-hand object location system 70 including a robotic hand having an in-hand camera 80, an object 90, a plurality of grippers 95a, 95b having linkages 97 disposed within the plurality of grippers 95a, 95b and a body portion 100. In some embodiments, object 90 may be in the form of a workpiece. Camera 80 may comprise a fish eye lens disposed therein to capture maximum information to a vision system 105b (FIG. 6) electrically attached to the same. The fish eye lens used with in-hand object location system 70 may obtain more information than a regular lens.

In some embodiments, gripping surfaces 75a, 75b include a layer of pressure generated illumination surfaces 85 comprised of pressure sensitive luminescent films. Using an in-hand object location system with pressure sensitive illumination can allow easy perception of the part of an object that has been gripped without the need for an elaborate light source. Illumination surfaces 85 may generate enough light to act as a light source for camera 80 to receive better imagery of object 90 as it is manipulated in-hand. In some embodiments, surfaces 85 illuminate upon coming into contact with an object 90 via a pressure-activated glow effect triggered by pressure on object 90. Gripping surfaces 75a, 75b, camera 80 and grippers 95a, 95b may be electrically and mechanically connected to a power source and control system 103 (FIG. 6) as described below.

In FIG. 5B, gripping surfaces 75a, 75b disposed on a surface of grippers 95a, 95b, may include a tactile sensor 75c including a first elastomer 72 disposed on a first side of a reflective film 74, a second elastomer 76 disposed on a second side of the reflective film 74, a light source 78 directed towards and incident upon the second elastomer 76, and a camera 79 directed towards the second elastomer 76 to capture a 3D image of object 90 in a similar manner as shown in FIGS. 3A and 3B. In some embodiments, elastomer 76 has a transparent or semi-transparent coating sandwiched adjacent the reflective film 74 as shown. First elastomer 72 is disposed and configured to be impacted by an object 90 to be sensed using tactile and 3D imaging via camera 79. By sandwiching the reflective film 74 between elastomers 72 and 76 any peeling of the reflective film 74 may be prevented during repetitive use, contact or manipulation of object 90 thereby making the tactile sensor 75c more durable over time. In some embodiments, tactile sensor 75c may be included within surfaces 75a, 75b described above herein to provide both a tactile and an illumination surface combination to view and manipulate object 90 during use.

One embodiment of the invention can be a rod or object 90 that needs to be picked and inserted into a fixture (not shown). In order for the in-hand object location system 70 to automatically calibrate itself, the robotic hand at 70 gets close enough to the object 90 and glides over the object 90 in a way that it covers one end of the rod or object 90 to the other. Now the robotic hand at 70 has information about the geometry of the object 90 relative to the robotic hand at 70. It may to do the same process for the fixture as well. Now as a form of smart training, the robotic hand at 70 will grasp this rod or object 90 from an end opposite to an end being inserted into the fixture.

Referring now to FIG. 6, there is a distributed control system 103 configured to operate and control the sensors 105a, 105b and the camera 80, as well as the robotic appendage or grippers 95a, 95b electro-mechanically connected via linkages 97 to body 100 discussed above. System 103 may include components, such as, a tactile sensor array 105a, a vision array 105b, an acute actuator control module 110a, a gross actuator control module 110b and a central controller 115 all connected via a communication bus 120 configure to pass at least two-way signals between all components. The tactile sensor array 105a may be electrically connected to 75a, 75b in a feedback loop to control the movement of grippers 95a, 95b with respect to, for example, a pick and place operation for object 90. The vision array 105b may be electrically connected to camera 80 in a feedback loop to control the relative movement of grippers 95a, 95b with respect to, for example, a pick and place operation for object 90. The acute actuator control module 110a is configured to control small and precise motion of grippers 95a, 95b and the gross actuator control module 110b is configured to control large or gross motion of gripper 95a, 95b during, for example, a pick and place operation. Central controller 115 may include a computer processor (CPU), an input/output (I/O) unit and a programmable logic controller (PLC) configured to program and operate the in-hand object location system 70 described herein.

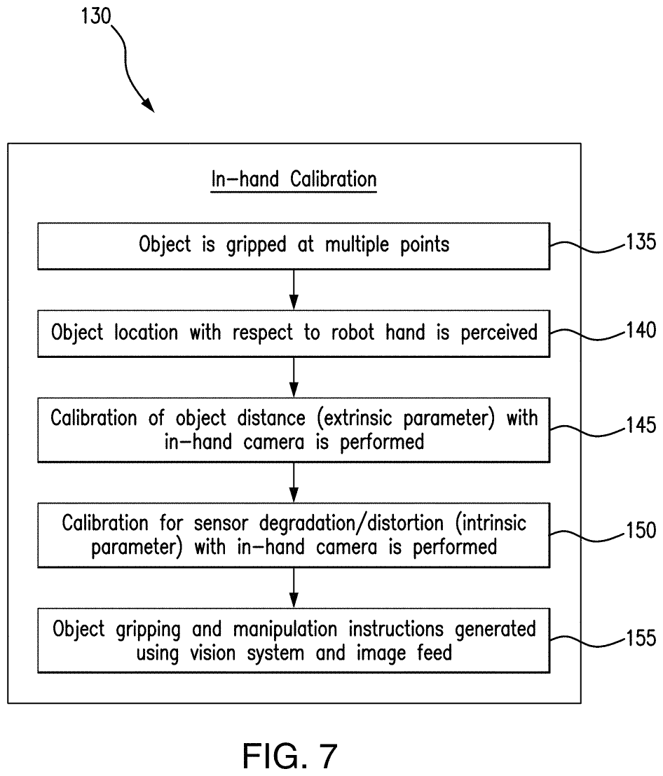

Referring now to FIG. 7, there is a flowchart illustrating an in-hand calibration method 130 for the object location system 70. At 135, an object 90 is gripped at multiple contact points. At 140, the object location with respect to the robotic hand is perceived by the in-hand object location system 70. At 145, a calibration of object distance (extrinsic parameter) with the in-hand camera 80 is performed. At 150, a calibration for any sensor 75a, 75b degradation/distortion (intrinsic parameter) with the in-hand camera 80 is performed. At 155, object gripping and manipulation instructions are generated using vision systems and image feed at 105a.

In certain embodiments, the in-hand object location system 70 may be calibrated in two ways: 1.) The first form of calibration is an intrinsic parameter calibration, includes conversion of the analog sensor signal to the location of the object 90 relative to in-hand sensor with approximately mm resolution. This may also include the conversion of pixel location to xyz coordinates. This calibration may be to compensate for distortion due to degradation of sensor or slight orientation corrections; and 2.) The second form of calibration is an extrinsic parameter calibration. The extrinsic parameters are for the model which transforms the object 90 coordinates relative to the in-hand sensors 75a, 75b to coordinates relative to the robot tool at 95a, 95b.

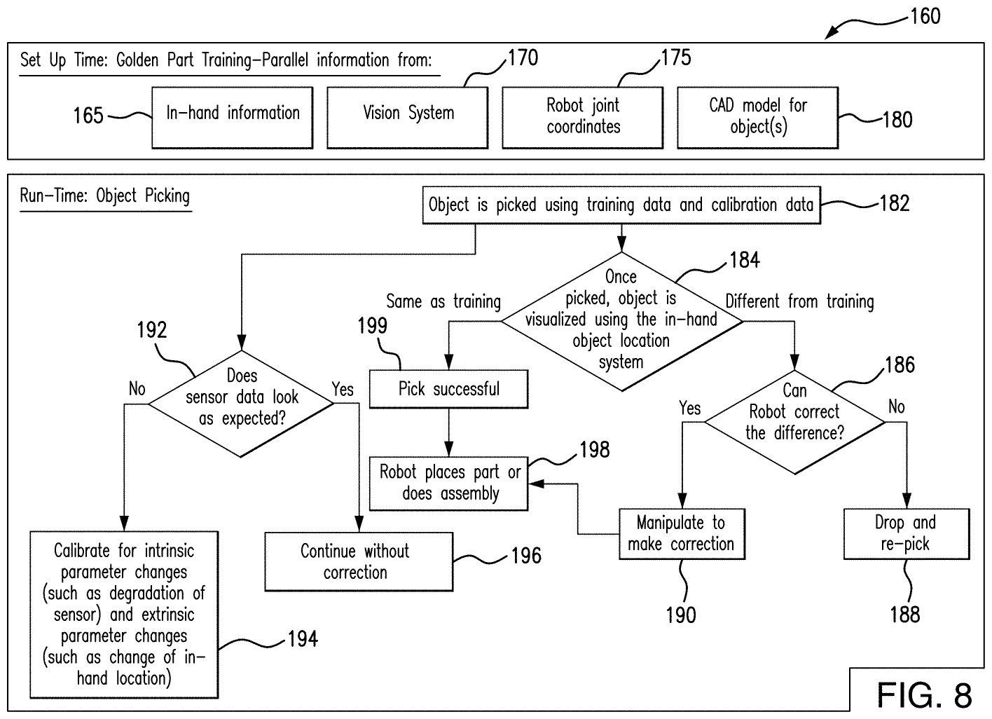

Referring now to FIG. 8, there is a flowchart illustrating a run-time calibration method 160 for the object location system 70. In some embodiments training data is gathered and provided. At 165, in-hand information is provided. At 170, vision system information is provided. At 175, robot joints/linkages coordinates are provided. At 180, a computer-aided design (CAD) model of the object 90 is provided.

At 182, object 90 is picked using training data and calibration data. At 184, once picked, the object 90 is visualized using the in-hand objection location system 70. If the visualization is different from the training steps discussed above, then at 186 a check is performed to see if the robotic hand at 70 can correct the difference. If the robotic hand at 70 cannot make the correction, the object 90 is dropped and re-picked to restart the process. If the robotic hand at 70 can make the correction, a manipulation at 190 is performed to make such correction. At 198, the robotic hand at 70 places the object 90 or performs an assembly of parts and the process ends or restarts to pick the next object. At 184, if the object is the same as in the training step a successful pick at 199 is performed. Then at 198, as discussed above, the robotic hand at 70 places the object 90 or performs an assembly of parts and the process ends or restarts to pick the next object.

At 192, a sensor 75a, 75b check is performed to see if the sensor data looks as expected based on object 90. If the sensor data does look as expected, then at 194 a calibration for intrinsic parameter changes (such as degradation of sensor) and extrinsic parameter changes (such as change of in-hand location) is performed. At 196, if the sensor data deviation when compared to the calibration data is under a threshold, then the object pick continues without correction.

In certain embodiments, a robotic hand at 70 can generate a known motion at 99 to calibrate the in-hand object location system 70. This would involve the robotic hand at 70 to repeat a gripping action or traversing the entirety of the object 90 in a known trajectory to calibrate according to the object's location information, such as the relative distance between different features on the object 90 or the relative distance the object 90 and the robotic hand itself. Since the image feed can serve as a calibration of distance of the grippers 95a, 95b from object 90 and dimensional information about the object 90 itself, this can allow automated calibration of the in-hand object location system 70. This will significantly optimize how the robotic hand at 70 will proceed with the next steps for object 90 manipulation, can be used to generate a smart suggestion for easier picking/gripping.

In some embodiments, the interesting utility of this invention also lies in the fact that the calibration can not only be done as an automatic calibration operation, as shown in the flowchart of FIG. 7 at 130, but because of run-time, calibration can also be done during run-time, as shown in flowchart of FIG. 8 at 160, 194.

The scope of the in-hand calibration movement 99 or grasping-attempts can also feed into the data already received by the vision system 170 and the initial synthetic data about the object 90.

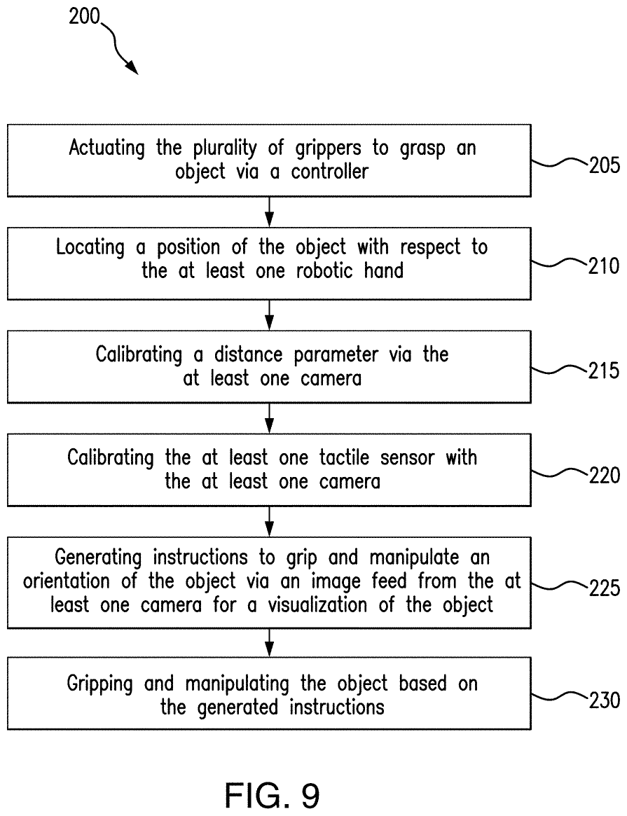

Referring now to FIG. 9, there is a method 200 of automated in-hand calibration according to an embodiment. Method 200 includes at 205 actuating the plurality of grippers to grasp a workpiece via a controller. At, 210, the method 200 includes locating a position of the object with respect to the at least one robotic hand. At 215, the method 200 includes calibrating a distance parameter via the at least one camera. At 220, the method 200 includes calibrating the at least one tactile sensor with the at least one camera. At 225, the method 200 includes generating instructions to grip and manipulate an orientation of the object via an image feed from the at least one camera and a visualization of the object. At 230, the method 200 includes gripping and manipulating the object based on the generated instructions.

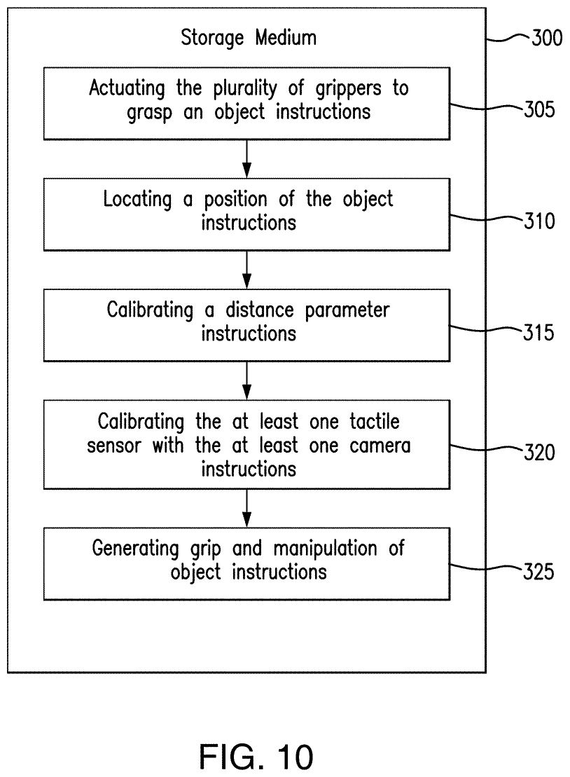

Referring now to FIG. 10, there is a block diagram for a system process contained in a memory as instructions for execution by a processing device coupled with the memory, in accordance with an exemplary embodiment of the disclosure. The instructions included on the non-transitory computer readable storage medium 300 cause, upon execution, the processing device of a vendor computer system to carry out various tasks. In the embodiment shown, the memory includes actuating instructions 305 for a plurality of grippers, using the processing device. The memory further includes locating instructions 310 for a position of the object, and calibrating instructions 315 for a distance parameter. The memory 300 further includes calibrating instructions 320 for the at least one tactile sensor with the at least one camera and generating instructions 325 for gripping and manipulating the object.

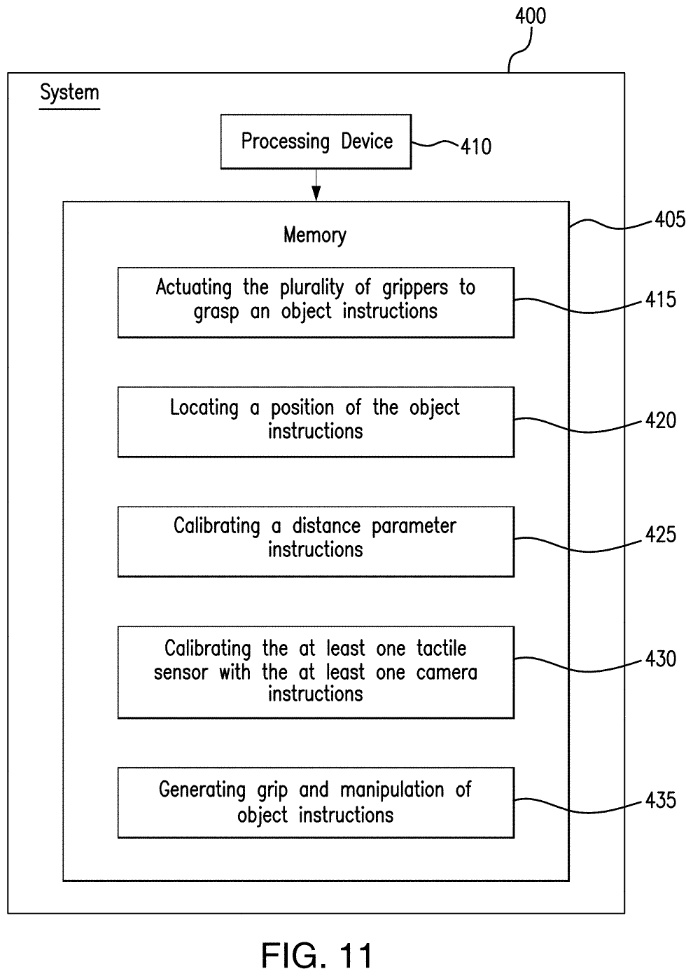

Referring now to FIG. 11, there is a flow diagram for a system process contained in a memory as instructions for execution by a processing device coupled with the memory according to an embodiment. In this embodiment, the system 400 includes a memory 405 for storing computer-executable instructions, and a processing device 410 operatively coupled with the memory 405 to execute the instructions stored in the memory. The processing device 410 is configured and operates to execute actuating instructions 415 for the plurality of grippers, and locating instructions 420 for a position of the object. Further, processing device 410 is configured and operates to execute calibration instructions 425 for a distance parameter, calibration instructions 430 for at least one tactile sensor with the at least one camera, and gripping and manipulating instructions 435 for an orientation of the object.

The various embodiments described herein may provide the benefits of a reduction in the engineering time and cost to design, build, install and tune a special finger, or a special fixture, or a vision system for picking, placing and assembly applications in logistics, warehouse or small part assembly. Also, these embodiments may provide a reduction in cycle time since the robotic hand can detect the position of the in-hand part right after picking the part. Further, these embodiments may provide improved robustness of the system. In other words, with the highly accurate in-hand object location and geometry, the robot can adjust the placement or assembly motion to compensate for any error in the picking. Moreover, these embodiments may be easy to integrate with general purpose robot grippers, such as the robotic YUMI hand, herein incorporated by reference, for a wide range of picking, placing and assembly applications.

The techniques and systems disclosed herein may be implemented as a computer program product for use with a computer system or computerized electronic device. Such implementations may include a series of computer instructions, or logic, fixed either on a tangible/non-transitory medium, such as a computer readable medium 300 (e.g., a diskette, CD-ROM, ROM, flash memory or other memory or fixed disk) or transmittable to a computer system or a device, via a modem or other interface device, such as a communications adapter connected to a network over a medium.

The medium 300 may be either a tangible medium (e.g., optical or analog communications lines) or a medium implemented with wireless techniques (e.g., Wi-Fi, cellular, microwave, infrared or other transmission techniques). The series of computer instructions (e.g., FIG. 11 at 415, 420, 425, 430, 435) embodies at least part of the functionality described herein with respect to the system 400. Those skilled in the art should appreciate that such computer instructions can be written in a number of programming languages for use with many computer architectures or operating systems.

Furthermore, such instructions (e.g., at 400) may be stored in any tangible memory device 405, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

As will be apparent to one of ordinary skill in the art from a reading of this disclosure, the present disclosure can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. Thus, it will be appreciated that the scope of the present invention is not limited to the above described embodiments, but rather is defined by the appended claims; and that these claims will encompass modifications of and improvements to what has been described.

Preferred embodiments of this invention are described herein, including the best mode known to the inventors for carrying out the invention. Variations of those preferred embodiments may become apparent to those of ordinary skill in the art upon reading the description herein. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of automated in-hand calibration, comprising:
providing at least one robotic hand including a plurality of grippers connected to a body;
providing at least one camera disposed in a peripheral surface of the plurality of grippers;
providing at least one tactile sensor disposed in the peripheral surface of the plurality of grippers;
actuating the plurality of grippers to grasp an object;
locating a position of the object with respect to the at least one robotic hand;
calibrating a distance parameter via the at least one camera;
calibrating the at least one tactile sensor with the at least one camera; and
generating instructions to grip and manipulate an orientation of the object via an image feed from the at least one camera for a visualization of the object,
wherein the at least one robotic hand, the plurality of grippers, the at least one camera and the at least one tactile sensor are electrically connected to a controller.

2. The method of claim 1, wherein the at least one camera includes a fish eye lens and is disposed in the body of the robotic hand.

3. The method of claim 1, further comprising providing at least one illumination surface disposed on the peripheral surface of the plurality of grippers.

4. The method of claim 3, wherein the at least one illumination surface is a pressure-activated luminescent surface.

5. The method of claim 1, wherein the plurality of grippers include mechanical linkages connecting the plurality of grippers to the body of the at least one robotic hand.

6. The method of claim 5, wherein the mechanical linkages include actuators configured to provide motion to the plurality of grippers via the controller.

7. The method of claim 3, wherein the at least one illumination surface is configured to provide a light source for the at least one camera.

8. The method of claim 1, wherein the controller comprises a tactile sensor array electrically connected to the at least one tactile sensor, a vision array electrically connected to the at least one camera, an acute actuator control module and a gross actuator control module connected to the robotic hand to move the plurality of grippers, and a central controller configured to connect to and to control each component via a communication bus.

9. The method of claim 1, wherein the at least one tactile sensor comprises a reflective film sandwiched between at least two tactile layers, a light source and a camera.

10. The method of claim 9, wherein the at least two tactile layers are elastomers.

11. The method of claim 9, wherein the camera and the light source are disposed adjacent only one of the at least two tactile layers, and
wherein the light source and the camera are electrically connected to the controller to render a 3D image of a touched surface by the at least one tactile sensor.

12. The method of claim 1, further comprising:
gripping and manipulating the object based on the generated instructions;
a first determining whether or not a feed from the visualization of the object correlates with the generated instructions;
a first correcting the gripping and manipulating of the object based on the first determining;
a second determining whether or not a feed from the at least one tactile sensor correlates with the generated instructions;
a second correcting the gripping and manipulating of the object based on the second determining; and
placing the object in an assembly of parts.

13. The method of claim 12, wherein the second correcting includes calibrating intrinsic and extrinsic parameter of the at least one tactile sensor if the feed from the at least one tactile sensor does not correlate with the generated instructions.

14. The method of claim 12, wherein the first correcting includes manipulating the object to correlate with the generated instructions if the feed from the visualization of the object does not correlate with the generated instructions.

15. A robotic hand, comprising:
a plurality of grippers and a body;
at least one camera disposed on a peripheral surface of the plurality of grippers;
at least one illumination surface disposed on the peripheral surface of the plurality of grippers; and
at least one tactile sensor disposed in the at least one illumination surface,
wherein the at least one robotic hand, the plurality of grippers, the at least one camera, the at least one illumination surface and the at least one tactile sensor are electrically connected to a controller.

16. The robotic hand device of claim 11, wherein the at least one illumination surface is a pressure-activated luminescent surface.

17. The robotic hand device of claim 11, wherein the plurality of grippers include mechanical linkages connecting the plurality of grippers to the body.

18. The robotic hand device of claim 14, wherein the mechanical linkages include actuators configured to provide motion to the plurality of grippers via the controller.

19. The robotic hand device of claim 11, wherein the at least one illumination surface is configured to provide a light source for the at least one camera.

20. A non-transitory computer-readable medium storing instructions that, when executed by a processor of a computer, cause the processor to perform operations comprising:
actuating the plurality of grippers to grasp an object;
locating a position of the object with respect to the at least one robotic hand;
calibrating a distance parameter via the at least one camera;
calibrating the at least one tactile sensor with the at least one camera; and
generating instructions to grip and manipulate an orientation of the object via an image feed from the at least one camera for a visualization of the object.
